(19) United States
(12) Patent Application Publication
(10) Pub. No.: US 2004/0132445 A1
(43) Pub. Date: Jul. 8, 2004

(54) Methods and systems of sharing mutual resources between an external device and a cordless telephone via a communications medium

(76) Inventors: Gary Rogalski, Richmond (CA); Douglas Alvarado, Surrey (CA); Ralph Tischler, Surrey (CA); Douglas Charney, Richmond (CA)

Correspondence Address: SHAW PITTMAN, IP GROUP, 1650 TYSONS BOULEVARD, SUITE 1300, MCLEAN, VA, 22102, US

(21) Appl. No.: 10/401,794

(22) Filed: Mar. 31, 2003

Related U.S. Application Data
(60) Provisional application No. 60/437,744, filed on Jan. 3, 2003.

(51) Int. Cl. H04Q 7/20

(52) U.S. Cl. 455/426.1

(57) ABSTRACT

Embodiments of the present invention relate to systems and methods for sharing mutual resources between an external device and a cordless telephone via a communication medium. According to an embodiment, a system includes a computing device coupled to a cordless telephone. The computing device includes a device controller, a device memory, and a device physical medium interface. The cordless telephone includes a telephone controller, a telephone memory, and a telephone physical medium interface. The computing device and the cordless telephone are coupled via the device physical medium interface and the telephone medium interface to provide for sharing mutual resources between the computing device and cordless telephone.

### CROSS-REFERENCE TO RELATED APPLICATION

This application claims the benefit of U.S. Provisional Patent Application Serial No. 60/437,744 filed Jan. 3, 2003, which is herein incorporated by reference in its entirety.

### BACKGROUND OF THE INVENTION

1. Field of the Invention

Embodiments of the present invention relate to cordless telephones. More particularly, embodiments of the present invention relate to systems and methods for sharing mutual resources between an external device and a cordless telephone via a communications medium.

2. Background Information

Portable computing devices such as Personal Digital Assistants (“PDAs”), notebook computers, and tablet computers are in widespread use. These portable computing devices can be powerful computing devices. For example, present portable computing devices are typically much more powerful computing devices than present cordless telephone systems.

Typically, these portable computing devices have the capability of storing contact information (e.g., which includes telephone numbers), a graphical user input interface, and audio input/output. Users of these portable computing devices usually have contact information regarding contacts (e.g., persons, companies, friends, family, etc.) they often call. But to place a call to a contact with a cordless phone, a user typically has to cause the contact information to be displayed on the portable computing device and then manually dial the call to the contact on the cordless phone. The portable computing device users cannot bridge between the portable computing device and cordless phone devices for the purpose of allowing the devices to share computing resources (e.g., hardware resources, software resources, etc.). Sharing computing resources would allow, for example, a PDA's phonebook to be shared with the cordless phone, and allow users to perform dialing, speakerphone activation, answering calls, straight from their PDA. In view of the foregoing, it can be appreciated that a substantial need exists for systems and methods that can advantageously provide for sharing mutual resources between an external device and a cordless telephone via a communications medium.

### BRIEF SUMMARY OF THE INVENTION

Embodiments of the present invention relate to systems and methods for sharing mutual resources between an external device and a cordless telephone via a communications medium. According to an embodiment, a system includes a computing device coupled to a cordless telephone. The computing device includes a device controller, a device memory, and a device physical medium interface. The cordless telephone includes a telephone controller, a telephone memory, and a telephone physical medium interface. The computing device and the cordless telephone are coupled via the device physical medium interface and the telephone medium interface to provide for sharing mutual resources between the computing device and the cordless telephone.

### BRIEF DESCRIPTION OF THE DRAWINGS

FIG. 1 is a system diagram illustrating an embodiment of the present invention.

FIG. 2 is another system diagram illustrating an embodiment of the present invention.

FIG. 3 is a further system diagram illustrating an embodiment of the present invention.

FIG. 4 shows a high-level flow diagram of a method in accordance with an embodiment of the present invention.

FIG. 5 shows another high-level flow diagram of a method in accordance with an embodiment of the present invention.

FIG. 6 is a flow diagram showing an event handler process in accordance with an embodiment of the present invention.

FIG. 7 is another flow diagram showing an event handler process in accordance with an embodiment of the present invention.

FIG. 8 is a flow diagram showing a process to set a main phone list in accordance with an embodiment of the present invention.

FIG. 9 is another flow diagram showing a process to set a main phone list in accordance with an embodiment of the present invention.

FIG. 10 is a flow diagram showing a process to show phone list records in the main phone list in accordance with an embodiment of the present invention.

FIG. 11 is another flow diagram showing a process to show phone list records in the main phone list in accordance with an embodiment of the present invention.

FIG. 12 is a flow diagram showing one or more processes to dial or store a phone number from a phone list record of the main phone list in accordance with an embodiment of the present invention.

FIG. 13 is another flow diagram showing one or more processes to dial or store a phone number from a phone list record of the main phone list in accordance with an embodiment of the present invention.

FIG. 14 is a flow diagram showing a dialing process in accordance with an embodiment of the present invention.

FIG. 15 is another flow diagram showing a dialing process in accordance with an embodiment of the present invention.

FIG. 16 is a flow diagram showing a process to store a name and number from a portable computing device to a cordless telephone in accordance with an embodiment of the present invention.

FIG. 17 shows an illustration of a custom PDA application in accordance with an embodiment of the present invention.

Before one or more embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

According to an embodiment of the present invention, portable computing devices and cordless phones can share computing resources, which allows the portable computing device and cordless phones to access all shared functionality including hardware, processing power, and software. There are known methods that allow bridging of information between devices. For example, one known method allows a user to synchronize phonebook information between a cellular telephone and a PDA via an infrared link or wireless link. Another method used in computer clusters allows interconnected computers to be used as a unified computing resource. However, embodiments of the present invention allow portable computing devices and cordless phones to share computing resources so that a user can access all shared functionality including hardware, processing power, and software. Moreover, while embodiments of the present invention relate to portable computing devices and cordless telephones, embodiments of the present invention also encompass allowing computing devices (e.g., portable computing devices, desktop computers, computer servers, etc.) and telephones (e.g., cordless telephones, corded telephones, wireless telephones, cellular telephones, etc.) to share computing resources so that one or more users can access shared functionality including hardware, processing power, and software.

According to an embodiment of the present invention, a PDA device (e.g., a Palm PDA, a Windows Pocket PC PDA, etc.) is programmed to perform cordless phone functionality and share the PDA memory resources, including storing phonebook information from the PDA into to cordless telephone, dialing the cordless telephone, and enabling the cordless base speakerphone. For example, enabling the cordless base speakerphone can allow the user to remotely answer the telephone (e.g., take the telephone off hook in response to an incoming telephone call) or participate in an ongoing telephone call (e.g., add the user to the telephone call via the speakerphone).

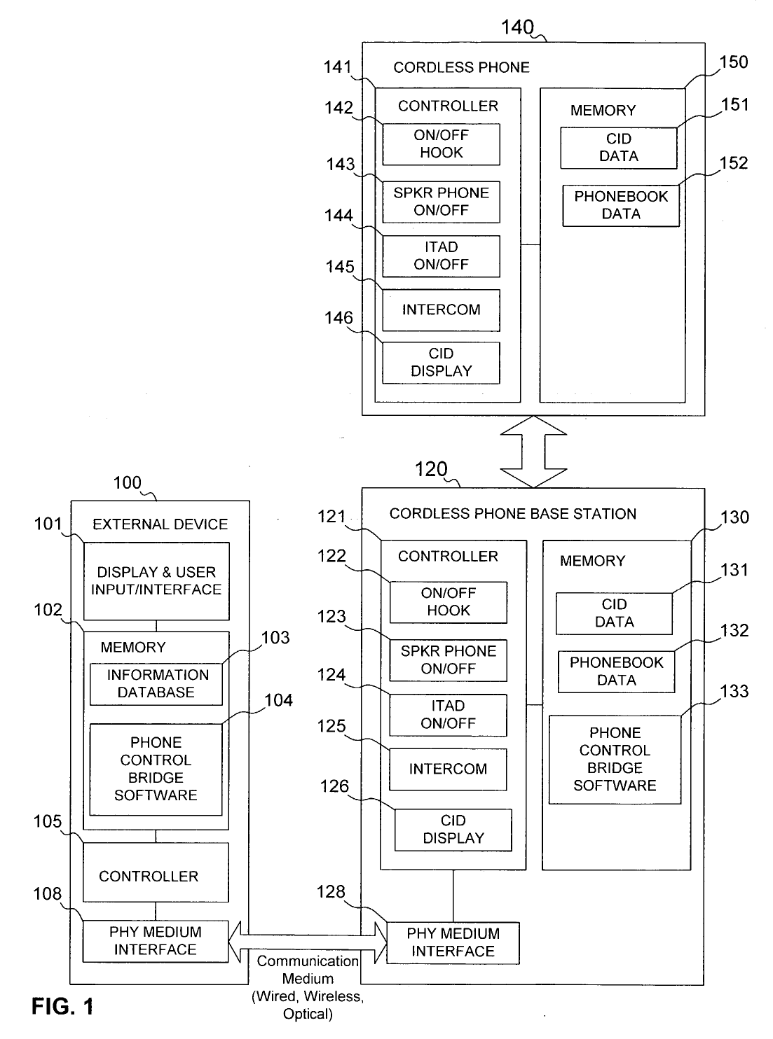

FIG. 1 is a system diagram illustrating an embodiment of the present invention. An external device 100 includes a display and user input/interface 101, a memory 102, a controller 105, and a physical medium interface 108 (“PHY medium interface”). The display and user input/interface 101 is coupled to the memory 102, which is coupled to the controller 105, which is coupled to the PHY medium interface 108. The memory includes an information database 103 and phone control bridge software 104.

Cordless phone base station 120 includes a controller 121, memory 130, and a PHY medium interface 128. The controller 121 can control cordless phone base station functions such as, but not limited to, on/off hook 122, speaker phone on/off 123, integrated telephone answering device (“ITAD”) on/off 124, intercom on/off 125, and caller identification (“CID”) display 126. The memory can store data such as, but not limited to, caller ID data 131, phonebook data 132, and phone control bridge software 133. Cordless phone base station 120 can communicate with external device 100 via the PHY medium interfaces 108, 128 and a communication medium. The communication medium can be wired, wireless, optical, and so on.

Cordless phone base station 120 can communicate with cordless phone 140. The Cordless phone can include a controller 141 and a memory 150. The controller 141 can control cordless phone functions such as, but not limited to, cordless phone on/off hook 142, speaker phone on/off 143, ITAD on/off 144, intercom on/off 145, and caller ID display 146. The memory 150 can include data such as, but not limited to, caller ID data 151 and phonebook data 152. The cordless phone base station 120 and cordless phone 140 can communicate via cordless phone radio frequency communications such as 900 MHz, 2.4 GHz, 5.8 GHz, a combination thereof, and so on.

The system illustrated in FIG. 1 allows shared resources between a computing device (e.g., external device 100) and a cordless phone system (e.g., cordless phone base station 120 and/or cordless phone 140). The system of FIG. 1 allows the computing device to expand the cordless phone functionality and add capabilities not normally found on a cordless handset and vice versa.

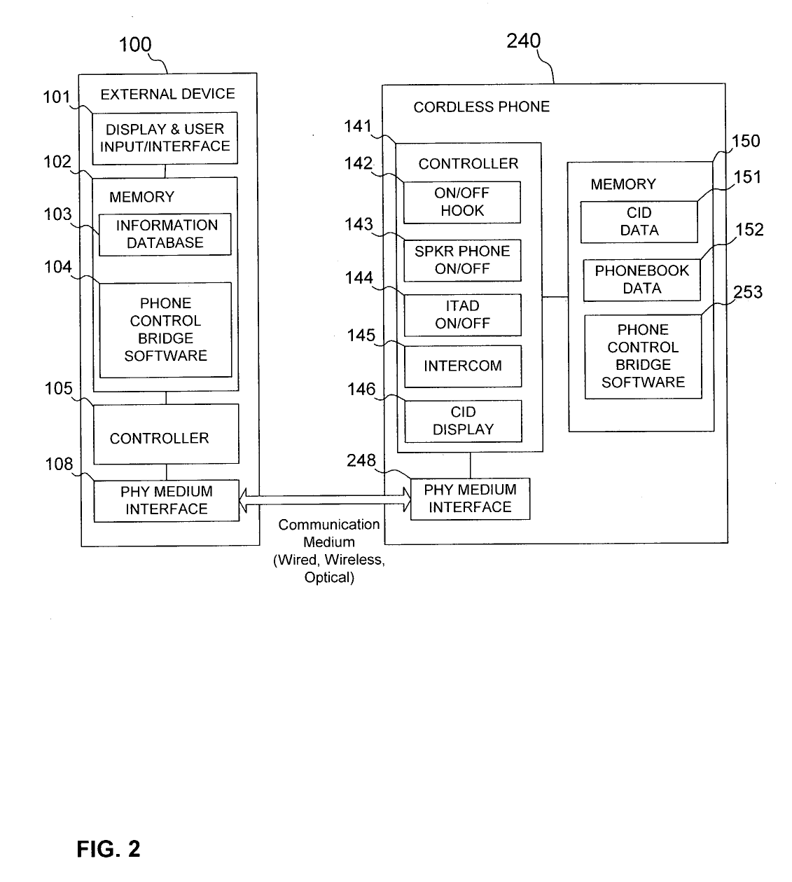

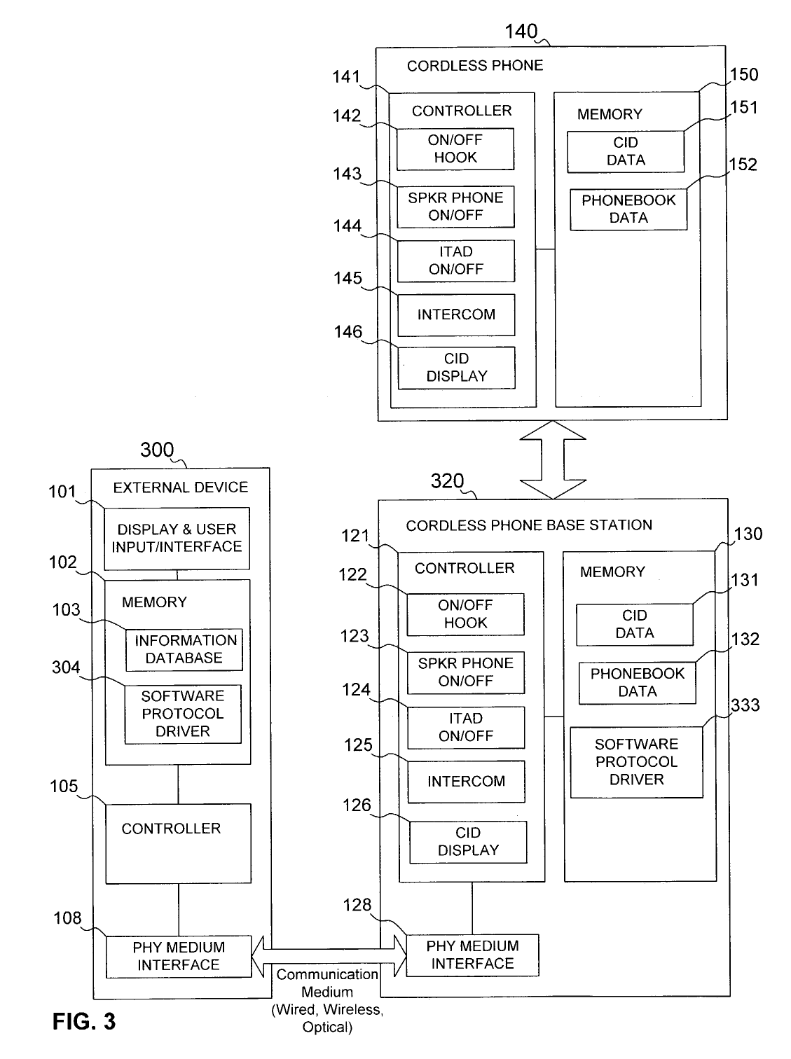

In accordance with embodiments of the present invention, such as, but not limited to, the systems illustrated in FIGS. 1-3, a physical medium interface is included in a cordless phone base station and/or a cordless phone handset. In certain embodiments, such as the system illustrated in FIGS. 1 and 2, phone control bridge functionality (e.g., phone control bridge software) is included in the external device to allow the external device to communicate with the cordless base station and/or cordless phone. For example, FIG. 2 shows a cordless phone 240 having a PHY medium interface 248 and phone control bridge software 253. In other embodiments of the present invention, such as the system illustrated in FIG. 3, each of (i) the external device 300 and (ii) the cordless phone base station 320 and/or cordless phone include software protocol drivers 304, 333 (e.g., IrOBEX protocol drivers) to allow the external device to communicate with the cordless base station and/or cordless phone.

Once a communications link between the cordless base and the external device is established, the external device can share its computing resources with the cordless phone and vice versa. This includes access to its computing capabilities, user interface, memory contents, and so on. Furthermore, the external device can now execute commands to and from the cordless phone and vice versa. These commands may be executed in either the cordless phone or the external device.

While there are known methods and systems to allow electronic devices to communicate, according to an embodiment of the present invention, external computing devices can share full hardware and software resources with a cordless phone and vice versa. Embodiments of the present invention can allow computing devices such as PDAs, laptops, etc. to share their computing power with a cordless phone by allowing it to interconnect two non-identical nodes via a common physical interface and provide resource/workload management methods. In an embodiment of the present invention, a user can view the cordless phone and external device as a single resource, thus gaining additional capabilities not available in prior known configurations.

The cordless phone (e.g., base station, handset, etc.) can be furnished with a physical interface, either at the manufacturing facility or as a user-added accessory. This interface can be identical to, or compatible with, the PHY medium interface in the external device and is not restricted to any transmission medium including but not limited to wireless, wired, or optical.

The external computing device can be programmed so that it can establish a communication link with the cordless phone. In an embodiment, the user can program the external device using known software updating methods. For example, a PDA device can be programmed via a PC during the synchronization process. Once the external device is programmed, a communications link is established by a user command, and both the external device and the cordless phone will be capable of receiving and transmitting commands initialized at either end of the node. This functionality allows both devices to act as a single resource. Thus, for example, in accordance with an embodiment of the present invention, the PDA is programmed to establish a communications link with a cordless base station and share computing resources via a common physical interface. The PDA can access to the phone functionality by allowing it to transmit commands to the cordless phone such as, for example, instructing the cordless base to dial a number, enabling speakerphone, turning the ITAD on/off, and so on. Furthermore, since a link exist between the two devices, a computing device with an audio input/output could now act as a virtual handset, thus allowing it to handle voice information to and from the cordless phone. In this case, the base station would provide the interface to the telephone network and convert the analog voice into digital packets, which the PDA device would process and convert back to analog information. From the user's point of view, the PDA would have cordless phone functionality.

In addition, the cordless phone can now send commands to an external device with spare computing power. For example, a computing intensive, voice recognition algorithm, could be executed in the external device via a command issued by the cordless phone. From the user point of view, the cordless phone would temporarily gain processing power from the computing device.

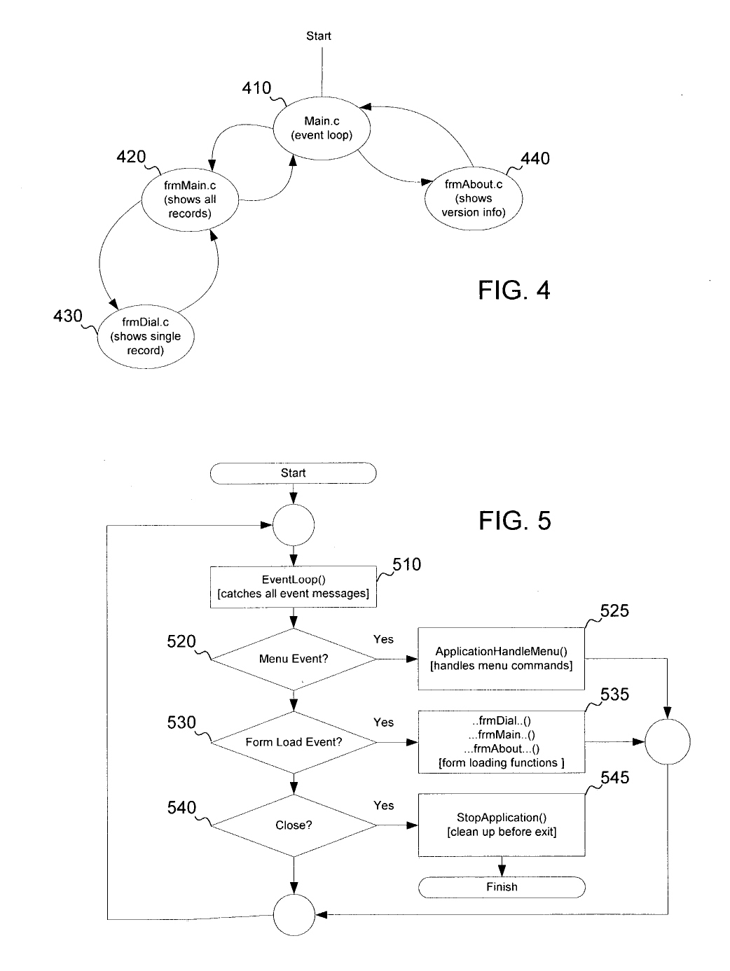

In an embodiment of the present invention, an optical physical interface was included in a cordless handset and a program was included in a PDA device. The embodiment allowed the PDA device to send commands and share resources with a cordless handset. For example, dialing a phone number stored in the PDA's memory, enabling speakerphone on the cordless handset or base station and memory contents synchronization. FIGS. 4 through 16 include flowcharts in accordance with this embodiment of the present invention.

FIG. 4 shows a high-level flow diagram of a method in accordance with an embodiment of the present invention. The method can be implemented by a plurality of software modules (“modules”). For example, a Main.c event loop module 410 can be coupled to a form About.c module 440, a form Main.c module 420, and a form Dial.c module 430. Form About.c module 440 can show software version information, form Main.c module 420 can show a listing of contact records, and formDial.c module 430 can show a single contact record.

FIG. 5 includes a plurality of software modules related to the Event Loop processing. Event Loop Module 510 can catch all event messages and is coupled to a plurality of decision modules including Menu Event decision module 520, Form Load Event decision module 530, and Close decision module 540. The Menu Event decision module 520 can determine if the event message is a Menu Event. If the event message is a Menu Event, then the Menu Event decision module 520 can call the Application Handle Menu module 525 which handles menu commands. If the event message is not a Menu Event, then Form Load Event decision module 530 can determine if the event is a Form Load Event. If the event message is a Form Load Event, the Form Load Event decision module 530 can call module 535 for execution of the various form loading functions such as frmDial, fimMain, and formAbout. Closed decision module 540 can determine if the event message is a Closed event message. When the event message is a Closed event message, module 545 can Stop Applications and clean up before exit.

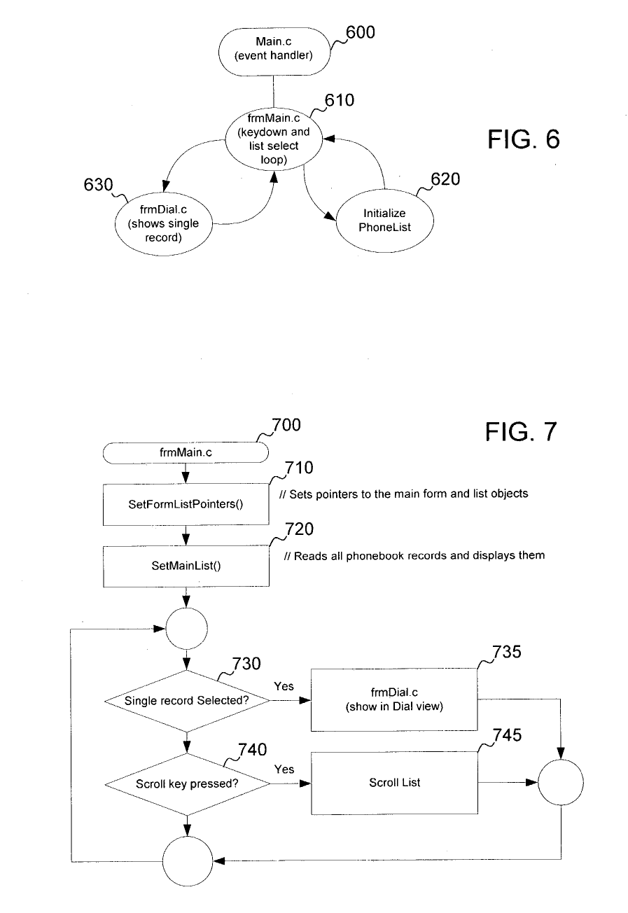

FIG. 6 is flow diagram showing an event handler process in accordance with an embodiment of the present invention. FIG. 6 shows a Main.c event handler 600 which is coupled to a formMain.c module 610, an Initialize Phone List module 620 and a formDial.c module 630. FormMain.c module 610 can include a loop for keydown and list select, Initialize Phone List module 620 can initialize a phone list, and formDial.c module 630 can show a single record.

FIG. 7 is another flow diagram showing an Event Handler process in accordance with the embodiment of the present invention. FormMain.c module 700 can call Set Form List Pointers module 710, which can set pointers to the main form and list objects. The Set Form List Pointers module 710 can call Set Main List module 720, which can read all phonebook records and display them. Decision module 730 and 740 can determine whether a single record was selected or whether a scroll key was pressed respectively. Single record Selected decision module 730 can call formDial.c. module 735, which can show a record in Dial view. When decision 740 determines that a scroll key was pressed, it can call Scroll List module 745 to cause the list of phonebook records to be scrolled.

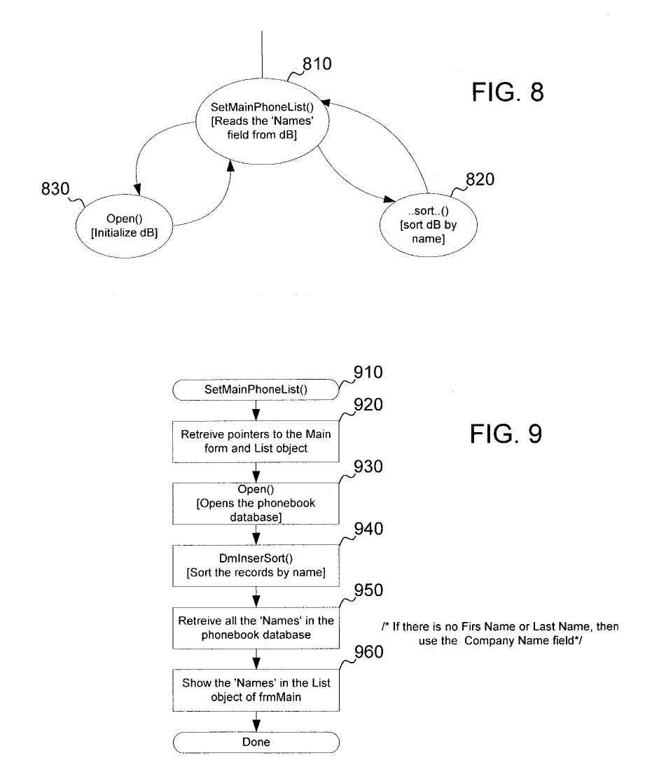

FIG. 8 is a flow diagram showing a process to set a main phone list in accordance with an embodiment of the present invention. FIG. 8 shows a Set Main Phone List module 810 coupled to an Open module 830 and a sort module 820. The Set Main Phone List module 810 can read contact names from the names field of a contact database. The Set Main Phone List module 810 can call Open module 830 to initialize the database, and sort module 820 can sort the database by the name field of the records in the database.

FIG. 9 is another flow diagram showing a process to set a Main Phone List in accordance with an embodiment of the present invention. Set Main Phone List module 910 can call module 920 to retrieve pointers to the Main form and List object. Module 930 can open the phonebook database and module 940 can sort the records by name. Module 950 can retrieve all the Names in the phonebook database. In an embodiment, if a database record has no First Name or Last Name, then module 950 can retrieve a Company Name field value from the data record. Module 960 causes the showing of the Names in the List object of new Name form.

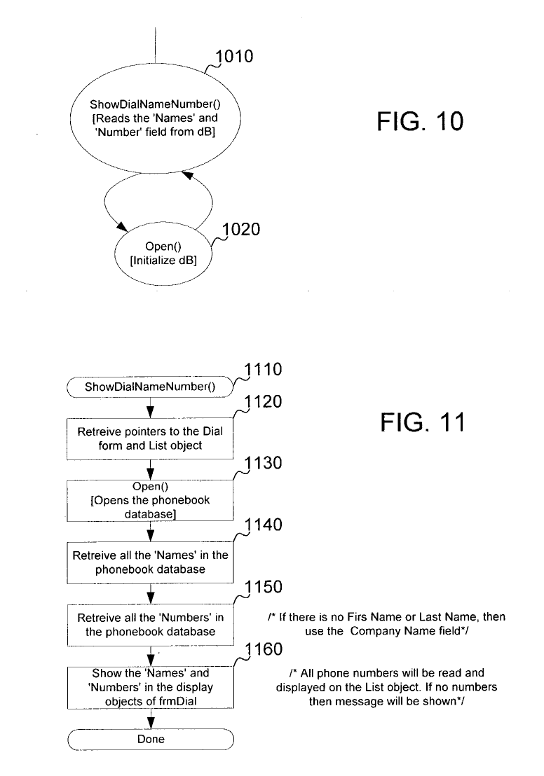

FIG. 10 is a flow diagram showing a process to show phone list records in the main phone list in accordance with an embodiment of the present invention. Module 1010 can read the Names and Number field from contact records of the database and module 1020 can initialize the database.

FIG. 11 is another flow diagram showing a process to show phone list records in the main phone list in accordance with an embodiment of the present invention. Module 1110 is a Show Dial Name Number module. Show Dial Name Number module 1110 can call module 1120 to retrieve pointers to the Dial form and List object. Open module 1130 can open the phonebook database. Module 1140 can retrieve all the Names in the phonebook database, and module 1150 can retrieve all the Numbers in the phonebook database. In an embodiment, if a record in the phonebook database does not contain a First Name or a Last Name, then the Company Name field value can be retrieved in place of the First Name or a Last Name. Module 1160 can cause the showing of the Names and Numbers in the display objects of the Dial form. In an embodiment, if there are no Numbers, than a message indicating that can be shown.

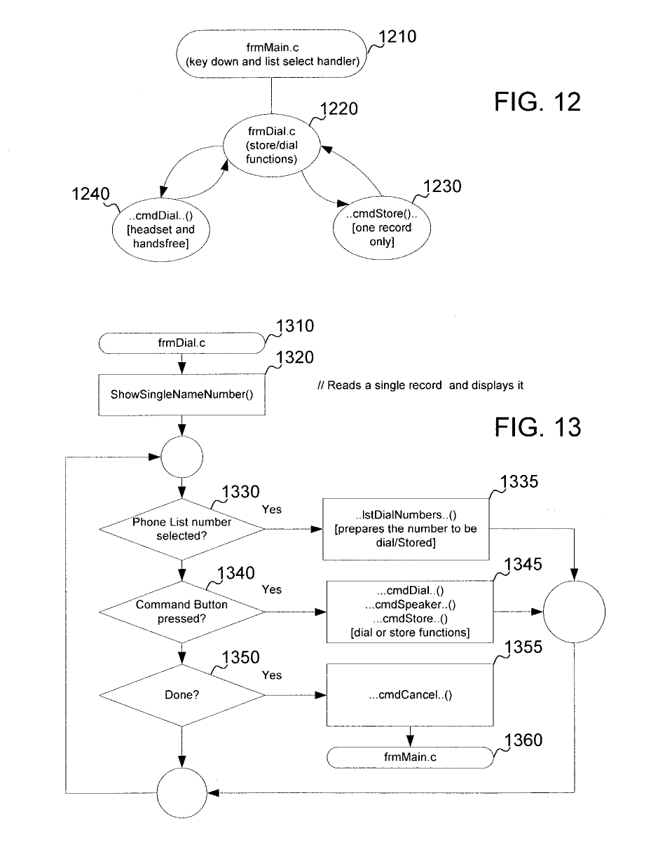

FIG. 12 is a flow diagram showing one or more processes to dial or store a phone number from a phone list record of the main phone list in accordance with an embodiment of the present invention. FormMain.c module 1210 can be coupled to formDial.c module 1220, cmdStore 1230, and cmdDial module 1240. FormMain.c module 1210 can handle key down and list select operations, formDial.c module 1220 can perform storing and dialing functions, cmdStore module 1230 can direct storing of a phonebook record, and cmdDial module 1240 can direct dialing including headset and handsfree dialing.

FIG. 13 is another flow diagram showing one or processes to dial or store a phone number from a phone list record of the main phone list in accordance with an embodiment of the present invention. formDial.c module 1310 can call Show Single Name Number module 1320, which can read a single phonebook and display it. A plurality of decision modules are couple to Show Single Name Number module 1320. Decision module 1330 can determine when a Phone List number has been selected and call Dial Numbers module 1335, which can prepare the Phone List number to be dialed or stored. Decision module 1340 can determine when a Command Button is pressed and call module 1345, which can direct dialing or storing functions such as cmdDial, cmdSpeaker, cmdStore, and so on. Decision module 1350 can determine whether the processes to dial or store a phone number are done and than call module 1355 which can execute a Cancel commend. The process can return to the main form via the formMain.c module 1360.

FIG. 14 is flow diagram showing a dialing process in accordance with an embodiment of the present invention. Dialing module 1410 can direct reading of a phone number to be dialed and assembling of data packet accordingly. For example, module 1420 can direct opening of serial infrared communications, such as at 9600 bps. Module 1430 can assemble the data packet for transmission. Module 1440 can cause the data packet to be transmitted via a serial infrared communications link. Module 1450 can close the serial infrared communications link.

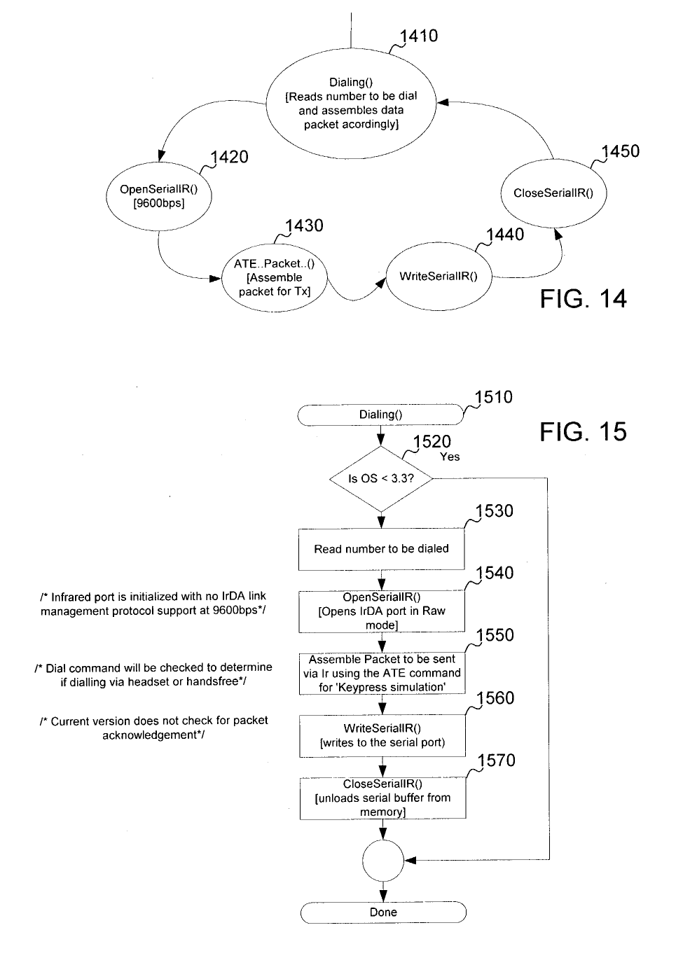

FIG. 15 is another flow diagram showing a dialing process in accordance with an embodiment of the present invention. Dialing module 1510 can call module 1520 to determine whether an Operating System is an appropriate version of the Operating System. Module 1530 can read a number to be dialed. Module 1540 can cause an Open Serial IR communications link to be initialized or established. Module 1550 can assemble a data packet to be sent via the infrared communications link using an ATE command for simulation of a Keypress. Module 1560 can write the data packet to the serial infrared port. Module 1570 can close the serial infrared communications link and unload serial buffer from memory. In an embodiment of the present invention, the infrared port is initialized with no IrDA link management protocol support a 9600 bps, the dial command will be checked to determine if dialing is via headset or handsfree, and the software modules need not check for packet acknowledgement.

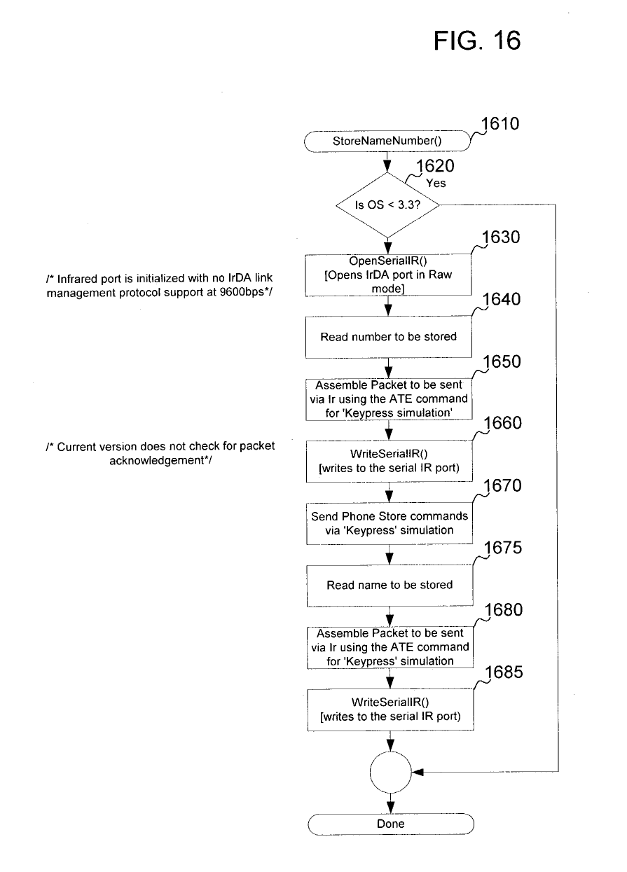

FIG. 16 is a flow diagram showing a process to store a name and number from a portable computing device to a cordless telephone in accordance with an embodiment of the present invention. Store Name Number module 1610 can call module 1620 to determine whether the Operating System of the external device is an appropriate version of the Operating System. Module 1630 can open a serial infrared communications link. In an embodiment, module 1630 opens an IrDA port in Raw mode. Module 1640 can read the number to be stored, and module 1650 can assemble the data packet that is to be sent via infrared using the ATE commend for simulating a Keypress. Module 1660 can write to the serial infrared port, and module 1670 can Send Phone Store commends via simulating Keypress. Module 1675 can read the name to be stored, and module 1680 can assemble the packet to sent via infrared using the ATE command for Keypress simulation. Module 1685 can write the assemble packet to the serial infrared port. In an embodiment of the present invention the infrared port is initialized with no IrDA link management protocol support at 9600 bps, and the software modules need not check for packet acknowledgement.

In an embodiment of the present invention, infrared connectivity allows a person to use their PDA (or PDAs) to perform dialing and phonebook synchronization of a cordless telephone. Infrared connectivity is an example of short-range wireless connectivity, and other embodiments of the present invention employ wireless connectivity technologies such as RF, Bluetooth, WiFi (e.g., IEEE 802.11), and so on. The embodiment includes a cordless handset with an Infrared Data Association (“IrDA”) port and a custom PDA application. In another embodiment, any PDA phonebook application using the Infrared OBject EXchange (“IrOBEX”) protocol is supported. IrOBEX embodiments allow connectivity to a wide range of IrDA enabled devices including PDAs, laptop computers and home PCs without the need for a custom PDA or computer application.

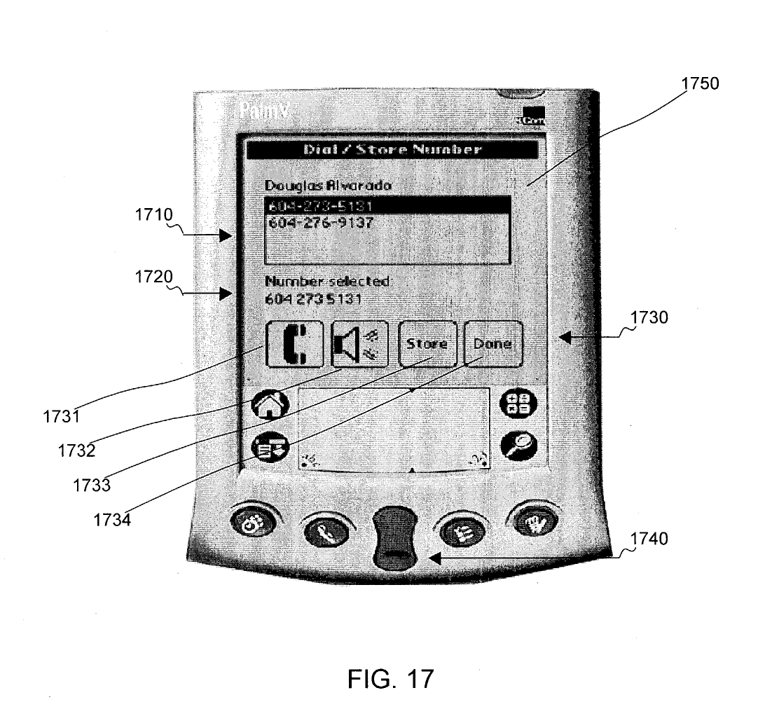

FIG. 17 shows an illustration of a custom PDA application in accordance with an embodiment of the present invention. For example, the custom PDA application can read and display the contents of the PDA's phonebook, such as the names and phone numbers stored in contact records of the PDA's phonebook. In an embodiment, the names and phones numbers are displayed in a list, and a name can be selected via a scroll button 1740 and touch screen 1750 so that a list of phone numbers 1710 associated with the current record are displayed. A selected number can be dialed or stored into the cordless handset. The selected number can be displayed as highlighted in the phone number list as well as in a number edit field 1720. The number edit field can also be used to add additional dialing characters, such as a “1” before the area code.

In an embodiment, the customer PDA application displays four “touch buttons” 1730. Headset dialing button 1731 is used to dial the cordless handset from the PDA device. Once a number is selected and this button (e.g., icon) is pressed, then the number and a dialing command are sent to the cordless handset. Handsfree dialing button 1732 is used to dial the cordless handset from the PDA device. The PDA device sends a number, dialing command and sets the cordless handset into a Handsfree mode. Store button 1733 is used to synchronize the PDA's phonebook with the cordless handset phonebook. The PDA device will send the selected number, name and a storing command to the headset. Done button 1734 returns the PDA application to all records displayed mode. In additional embodiments of the present invention, a user has a choice of selecting a single or multiple records to synchronize with their cordless handset. The transfer speed of the IrDA data can be significantly faster since the current speed of 9,600 bps can be increased up to 115.2 Kbps. Data transmission reliability and/or phonebook synchronization from the cordless handset to the PDA device can be provided.

As used to describe embodiments of the present invention, the term “coupled” encompasses a direct connection, an indirect connection, or a combination thereof. Two devices that are coupled can engage in direct communications, in indirect communications, or a combination thereof. Moreover, two devices that are coupled need not be in continuous communication, but can be in communication typically, periodically, intermittently, sporadically, occasionally, and so on. Further, the term “communication” is not limited to direct communication, but also includes indirect communication.

In accordance with an embodiment of the present invention, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

Embodiments of systems and methods for sharing mutual resources between an external device and a cordless telephone via a communications medium have been described. In the foregoing description, for purposes of explanation, numerous specific details are set forth to provide a thorough understanding of the present invention. It will be appreciated, however, by one skilled in the art that the present invention may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the present invention.

In the foregoing detailed description, systems and methods in accordance with embodiments of the present invention have been described with reference to specific exemplary embodiments. Accordingly, the present specification and figures are to be regarded as illustrative rather than restrictive.

What is claimed is:

1. A system for sharing mutual resources between an external device and a cordless telephone via a communications medium, the system comprising:
a computing device including a device controller, a device memory, and a device physical medium interface;
a cordless telephone coupled to the computing device, the cordless telephone including a telephone controller, a telephone memory, and a telephone physical medium interface;
whereby the computing device and the cordless telephone are coupled via the device physical medium interface and the telephone medium interface to provide for sharing mutual resources between the computing device and the cordless telephone.

2. The system of claim 1, wherein the computing device includes a display and user input interface.

3. The system of claim 1, wherein the computing device includes an information database.

4. The system of claim 3, wherein the information database is a personal information manager.

5. The system of claim 3, wherein the information database includes a plurality of contact records.

6. The system of claim 5, wherein a contact record includes a name and phone number.

7. The system of claim 1, wherein the device memory includes phone control bridge software.

8. The system of claim 7, wherein the telephone memory includes phone control bridge software.

9. A system for sharing mutual resources between an external device and a cordless telephone via a short-range wireless communications medium, the system comprising:
a cordless telephone having a telephone controller, a telephone memory and a short-range wireless communications medium interface,
wherein the telephone memory includes an information database and the cordless telephone is configured to communicate wirelessly with an external device.

10. The system of claim 9, wherein the telephone memory includes phone control bridge software.

11. The system of claim 10, wherein the phone control bridge software is configured to communicate with an external device, the external device including an information database and phone control bridge software.

12. The system of claim 9, wherein the telephone memory includes a software protocol driver.

13. The system of claim 12, wherein the software protocol driver is configured to communicate with an external device, the external device including an information database and phone control bridge software.

14. The system of claim 12, wherein the physical layer interface is an IrDA compliant interface.

15. The system of claim 12, wherein the software protocol driver is an IrOBEX compliant driver.

16. The system of claim 9, further comprising a portable computing device, the portable computing device including a device controller, a device memory, and a short-range wireless communications medium interface.

17. The system of claim 16, whereby the computing device and the cordless telephone are coupled via the device physical medium interface and the telephone medium interface to provide for sharing mutual resources between the computing device and the cordless telephone.

18. A method for enabling two or more non-identical devices to share resources, the method compromising:
furnishing a first device of the two or more non-identical devices with a physical interface common to at least one other device of the two or more non-identical devices;
providing the first device with translation software that allows the first device to communicate and receive messages to and from the other device using a common protocol;
providing a resource manager to manage resources and route tasks to the first device and the other device according to their computing capability and availability; and
providing central management software that allows users to view enhanced shared resources of the first device and the other device as a single entity.

19. The method of claim 18, wherein the first device is a portable computing device and the other device is a cordless telephone.

20. The method of claim 19, wherein the portable computing device is a personal digital assistant.
